(19) United States
(12) Patent Application Publication
(10) Pub. No.: US 2025/0118228 A1
(43) Pub. Date: Apr. 10, 2025

(54) Anti-Slip Dog Leash Tag

(71) Applicant: SpokesPup, LLC, Rolesville, NC (US)

(72) Inventors: David Rowland, Rolesville, NC (US); Kyle Rowland, Rolesville, NC (US); Paul Bradley Forrest, Cary, NC (US)

(21) Appl. No.: 18/912,086

(22) Filed: Oct. 10, 2024

Related U.S. Application Data
(60) Provisional application No. 63/589,189, filed on Oct. 10, 2023.

(51) Int. Cl. G09F 3/06; A01K 27/00; G09F 3/02

(52) U.S. Cl. CPC G09F 3/06; A01K 27/006; G09F 3/0288; A01K 27/003

(57) ABSTRACT

A leash tag that is attached directly along the length of the leash conveys the approachability of a dog at a glance to others. Anti-slip features keep it in place for a variety of leash sizes, materials, and shapes without sliding down. It contains panels that can feature multiple messages and be interchanged without removing the tag from the leash, and message panels are stored within the unit. The messages define a universal communication system for dog approachability. This system conveys information about how a dog should be approached that is intuitive and easy to understand through the coordinated use of color-coding, graphic icons, and text.

### RELATED APPLICATIONS

The present application claims benefit of U.S. Provisional Application 63/589,189, which was filed Oct. 10, 2023, the disclosure of which is incorporated herein by reference in its entirety.

### TECHNICAL FIELD

This invention is a pet product designed to attach directly on the cord or band of a dog leash, positioned between the dog and the dog walker in an optimal position to provide a clear and concise message at a glance about how a dog should be approached by indicating their behavior, demeanor and other characteristics.

### BACKGROUND

Dog lovers know that people are generally anxious in situations where they encounter an unknown dog. This can be people walking their own dog or just walking without a pet but when there is an imminent encounter with a dog this creates uncertainty and anxiety around how that dog should be approached. Dogs have certain needs and likes that need to be communicated.

For example, it is quite common that people mention their dog is afraid of men. Other dogs have a history of abuse or neglect that cause them to be fearful of certain situations. This can be exacerbated in urban environments or crowded indoor areas where close contact between people and dogs or dogs and dogs cannot be avoided. Thus, the need for an effective tool to communicate, at a glance, how a dog should be approached by others. Any scenario where a person encounters a dog without any information about the behavior, demeanor, and approachability of a dog could be improved by having that information, at a glance, on the dog leash. Readily available information about dogs' characteristics is a net benefit to all parties involved in any encounter.

Current variations of a dog leash tag lack several important features. This includes the ability to be fixed in place along the length of the dog leash without sliding down to the dog collar. Leash tags display one message or meaning that is typically written in a horizontal orientation. The horizontal orientation of text and messages means that text is not always legible in different orientations and as the leash tags are rotated around the axis of a leash, they may appear upside down. A dog leash is not typically perpendicular to the ground as the dog leads the owner on a walk. Therefore, horizontal text is commonly displayed upside down.

There is no standardized system to communicate behavior, demeanor and how a dog should be approached that is intuitive and universally understood at a glance. The messages are typically color coded and each tag can have up to 10 different colors and phrases without a clear consistent theme.

Overall, there is a lack of consistency in how leash tags are attached to the leash, and the type of message they communicate. Other attempts at conveying a dog's approachability directly on the dog include collar wraps and dog vests. A collar or vest cannot be easily interchanged, requires more significant effort, and sometimes requires direct contact with the dog to implement the devices.

### SUMMARY

A leash tag that is attached directly along the length of the leash conveys the approachability of a dog at a glance to others. Anti-slip features keep it in place for a variety of leash sizes, materials, and shapes without sliding down. It contains panels that can feature multiple messages and be interchanged without removing the tag from the leash, and message panels are stored within the unit. The messages define a universal communication system for dog approachability. This system conveys information about how a dog should be approached that is intuitive and easy to understand through the coordinated use of color-coding, graphic icons, and text.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A is an exploded perspective view of an exemplary leash tag showing the graphic panels before they are inserted into the leash tag and the leash tag in a closed orientation according to a first embodiment.

FIG. 1B is perspective view of the leash tag showing the graphic panels attached to the leash tag in a closed orientation according to the first embodiment.

FIGS. 2A and 2B are perspective views showing the interior of the leash tag in an open orientation according to the first embodiment.

FIGS. 3A and 3B are perspective views showing the exterior of the leash tag in a closed orientation according to the first embodiment.

FIG. 4A is perspective view showing the interior of the leash tag in an open orientation with a flat cord resting inside the enclosure according to the first embodiment.

FIG. 4B is perspective view showing the interior of the leash tag in an open orientation with a round cord resting inside the enclosure according to the first embodiment.

FIG. 5A is a close-up perspective view of the interior of the leash tag according to the first embodiment.

FIG. 6A is perspective view showing the exterior of the leash tag in an open orientation according to a second embodiment.

FIG. 6B is perspective view the interior of the leash tag in an open orientation according to the second embodiment.

FIG. 7A is a perspective view showing a more compact design of the leash tag in an open and closed orientation according to the first embodiment.

FIG. 8A illustrates an exemplary set of graphic panels according to one embodiment.

FIG. 8B illustrates an alternate set of graphic panels according to another embodiment.

### DETAILED DESCRIPTION

The terminology used herein is for the purpose of describing embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “compromises”, and/or “compromising”, when used in this specification, specify the presence of stated features, steps, operations, elements, and/or components, but do not preclude the presence or addition of one or more other features, steps, operations, elements, components, and/or groups thereof.

The Anti-Slip Dog Leash Tag herein referred to as “leash tag” and/or the “device” is an enclosure that has two Figure sections that close together to secure the cord or leash between them. At least one of the parts has resilient bands on the interior surface to clamp onto the leash. When the parts are snapped together there is an opening that a cord can pass through. The device is made up of two halves of an enclosure whereby when a leash is positioned on one half and the device is closed, the leash is captured between the two. In some embodiments the two halves are connected via a living hinge. When captured the leash or cord is deterred from moving in a lateral motion within the device. This allows the device to stay in place along the length of the leash. The leash tag housing has a variety of anti-slip features that are designed to capture and hold different leash sizes and shapes. Each feature in various embodiments works together with the others to accommodate the needs of different leashes. The common plane is the center plane where two halves of the leash tag come together and is the center of the cord cross section when inserted in the device.

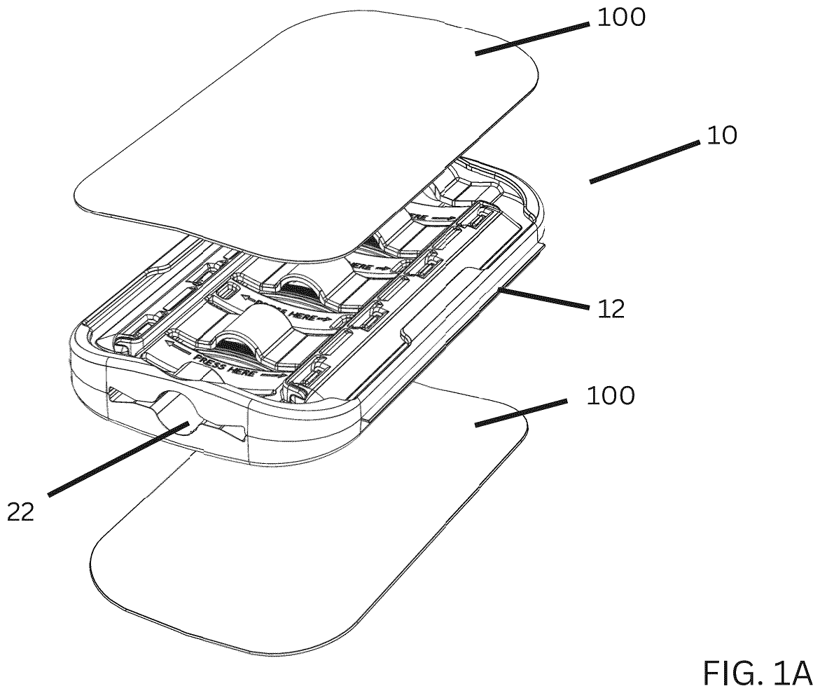

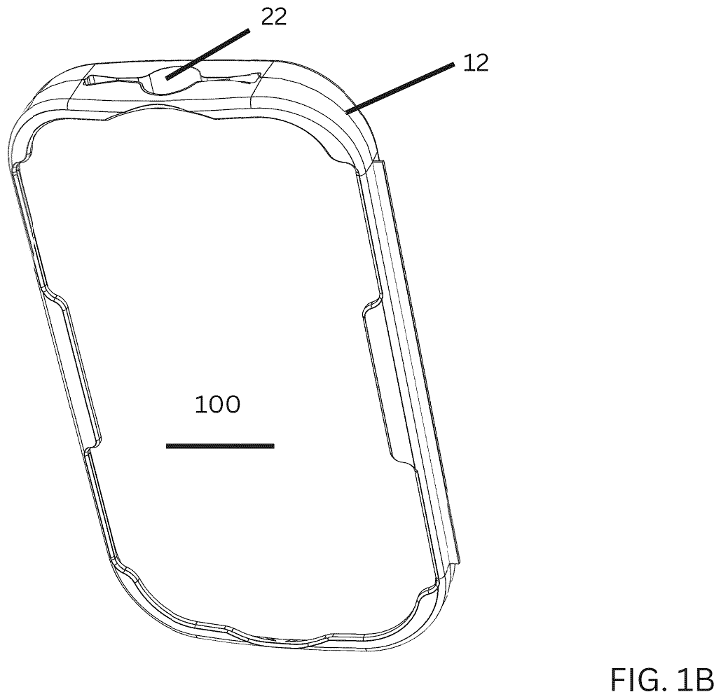

Referring now to the drawings, and particularly to FIGS. 1A and 1B, the leash tag according to one exemplary embodiment is shown and indicated generally by the numeral 10. The leash tag 10 includes a housing 12 having a channel 22 formed therein that removably attaches to a pet leash and a plurality of interchangeable graphics panel 100 that can be attached to and displayed on the housing 12 to provide information about the approachability of the user's pet.

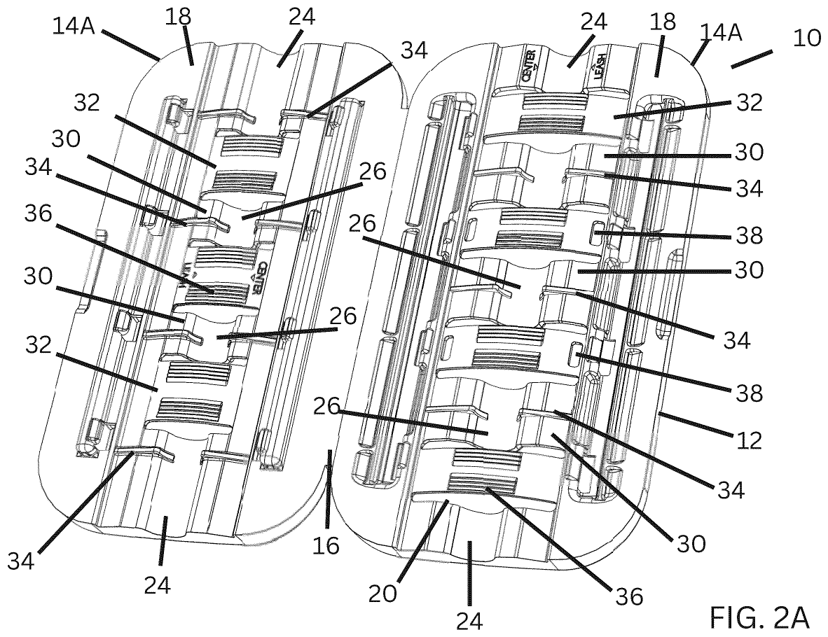

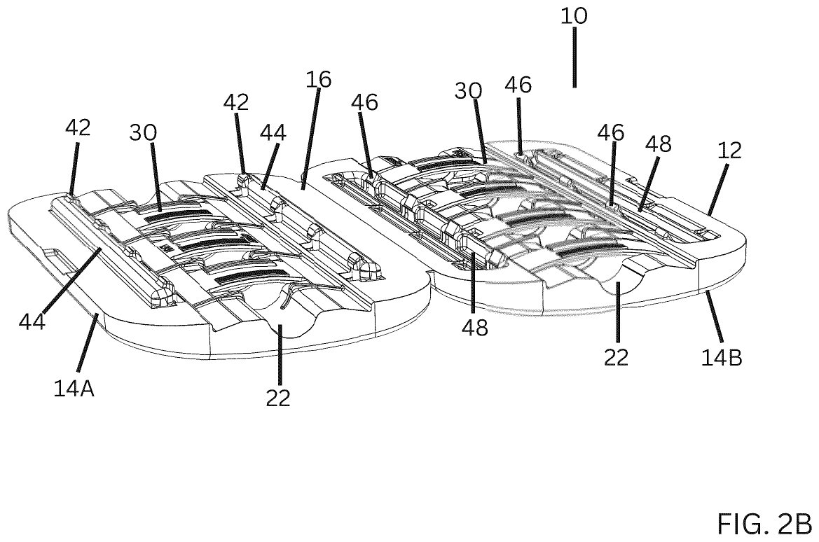

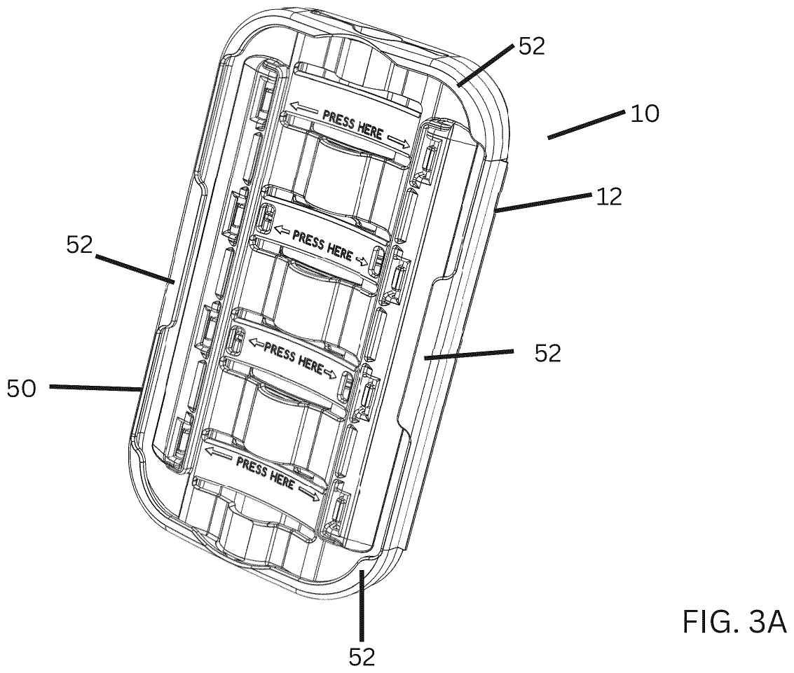

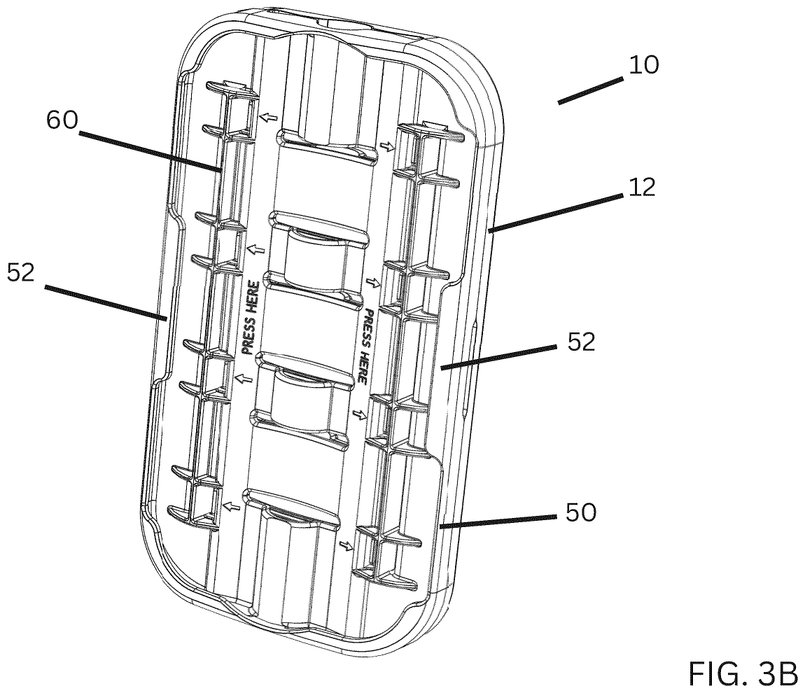

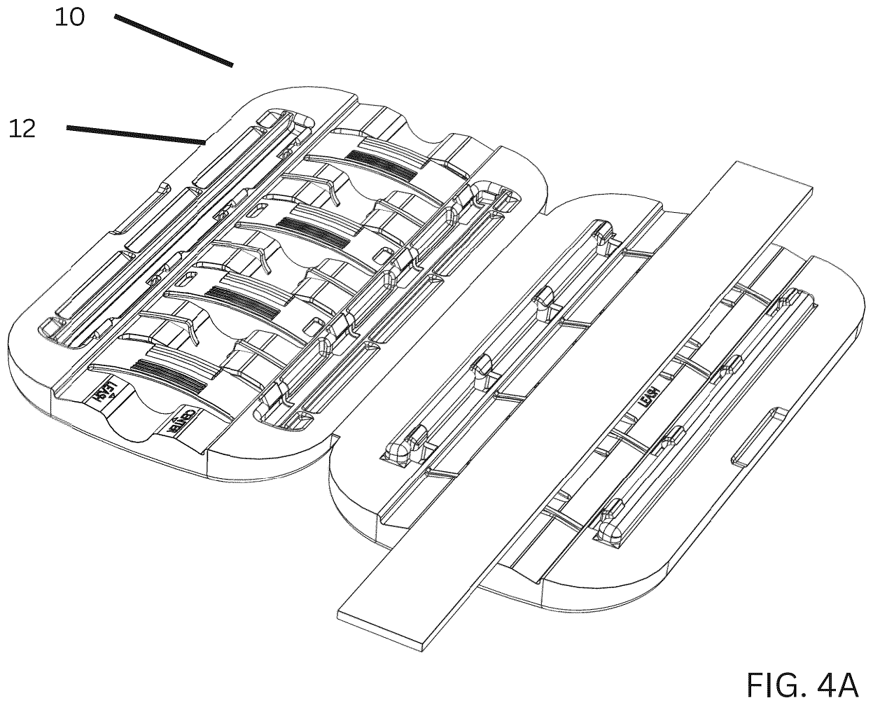

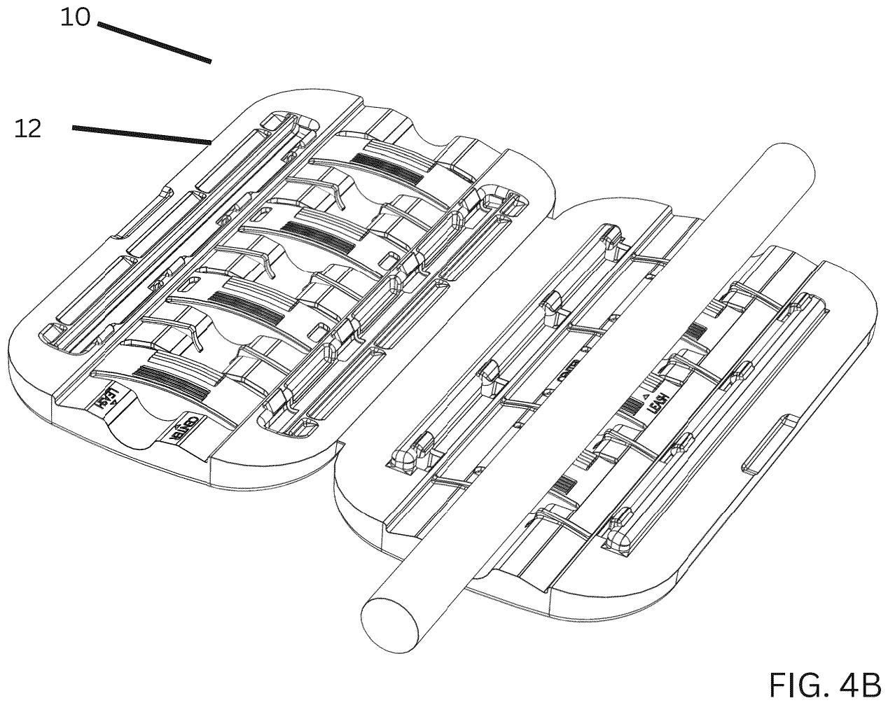

FIGS. 2A and 2B show the housing 12 in an open configuration, while FIGS. 3A and 3B show the housing 12 in a closed configuration. The housing 12 includes first and second housing sections 14A and 14B connected by a live hinge 16. Housing sections 14A and 14B each include a continuous border 18 surrounding a central opening 20. The housing sections 14A and 14B are movable between open and closed positions respectively and include a closure mechanism 40 to secure the housing sections 14A, 14B together in the closed position.

The channel 22 within the housing 12 allows a pet leash to pass through the housing 12 from one end to the other when the housing 12 is closed. In a preferred embodiment, the channel 22 is shaped to accept both a flat pet leash and round pet leash. In other embodiments, the channel 22 can be shaped to accept either a flat leash or a round leash.

The channel 22 in the housing 12 comprises a plurality of channel sections 24, 26 spaced along a longitudinal axis of the channel 22. The channel sections 24, 26 can vary in size and shape to accommodate different sizes and shapes of leashes. The leash is captured in the channel sections 24, 26 when the housing is closed 12.

First channel sections 24 are formed on the inside of the border 18 of housing sections 14A and 14B at opposite ends of the housing 12. The first channel sections 24 define channel openings at opposite ends of the housing 12 when the housing 12 is closed. Second channel sections 26 are formed in first resilient bands 30 on housing sections 14A and 14B that span the central opening 20 from the border 18 on one side of the housing section 14A, 14B to the border 18 on the opposite side of the housing section 14A, 14B.

Second resilient bands 32 on housing sections 14A and 14B are arranged in opposition to respective channel sections 24, 26 and span the central opening 20 from the border 18 on one side of the housing 12 to the border on the opposite side of the housing 12. The second resilient bands 32 are configured to engage the leash when the housing 12 is closed and to press the leash into respective channel sections 24, 26. Preferably, the resilient bands 32 arch over the central openings in respective housing sections 14 A and 14B so that the resilient bands 32 rise above the common plane of the housing sections 14A and 14B. The resilient bands 32 are designed to deform or flex when the housing 12 is closed to apply pressure to the leash disposed with channel 22.

In a preferred embodiment, the resilient bands 30, 32 are arranged in alternating fashion on both housing sections 14A and 14B, while resilient bands 30, 32 on different housing sections 14A and 14B are staggered. With this arrangement, the resilient bands 30 on one housing section 14A, 14B are opposite resilient bands 32 on the other housing section 14A, 14B. Two extra resilient bands 32 are formed in housing section 14B in opposition to a channel section 24 on housing section 14A. Thus, each of the resilient bands 32 is configured to press the leash into a respective channel section 24, 26. This arrangement of the resilient bands 30, 32 creates a serpentine effect on a leash passing through the housing 12.

In other embodiments, the resilient bands 30 may be all formed in one housing section 14A, 14B and the resilient bands 32 may be all formed in the other housing section 14 A, 14B. In still other embodiments, the resilient bands 30 on one housing section 14A, 14B may be opposite resilient bands 30 on the other housing section 14A, 14B, while resilient bands 32 on one housing section 14A, 14B are opposite resilient bands 32 on the other housing section 14A, 14B. In still other embodiments, resilient bands of only one type 30, 32 can be used. Different types and arrangements of the resilient bands 30, 32 can be used to tailor the present invention for use with different sizes and shapes of pet leashes.

In some embodiments, the first resilient bands 30 include standing ribs 34 and the second resilient bands 32 include grip lines 36 or other similar gripping features. The standing ribs 34 are designed to apply pressure to the leash in a pinching manner when the housing 12 is closed. Because the standing ribs 34 are attached to the resilient band 30, the standing ribs 34 may rise slightly above the common plane and flex out of the way when the housing 12 is closed. The grip lines 36 are designed to increase frictional forces on the leash and deter sliding motion of the leash when the housing 12 is closed. The grip lines 36 allow for a consistent grip and texture of the contact surface regardless of material properties. Various textures and form factors could be used to achieve the desired consistent effect. Different arrangements of the resilient bands 30, 32, standing ribs 34, and gripping lines 36 can create different capture effects.

In some embodiments, the resilient bands 32 may include band cutouts 38. The band cutouts 38 in this embodiment are rectangular areas of the resilient bands 32 where material has been removed. The band cutouts 38 provide additional flexibility in some of the resilient bands 32 to allow for expansion when cords or leashes are captured. The design of the band cutouts 38 can manipulated where more material is removed on each resilient band 32, more resilient bands 32 feature the band cutouts 38, and different patterns of the band cutouts 38 are present to allow for flexibility.

The closure mechanism 40 comprises a plurality of male snap heads 42 on housing section 14A that releasably engage with mating female snap heads 46 on housing section 14B. The male snap heads 42 are spaced along snap bars 44 that are molded into the border 18 of housing section 14A on opposite sides of the central opening 20 and extend parallel to the channel 22. The snap bars 44 in this embodiment have a semi-circular cross-section and extend above the common plane separating the first and second housing sections 14A, 14B in the closed position. The female snap heads 46 are spaced along alignment rails 48 that are molded into the border 18 of housing section 14B on opposite sides of the central opening 18 and extend parallel to the channel 22. The alignment rails 48 on housing section 14B comprise semi-circular channels configured to receive the snap bars 44 on housing section 14A when the housing 12 is closed.

The male and female snap heads 42, 46 in this embodiment are wedge-shaped snap heads that extend above the common plane. The wedge shape of the female snap head 46 accepts the corresponding wedge shape of the male snap head 42 and impedes the male snap head 42 from disengaging after snapping into place. The female snap head 46 is designed to hold and impede the movement of the male snap head 40 after it snaps past it and into place in the closed position of the leash tag. The female snap head 46 can be designed at an angle to make it easier for the male snap head 42 to snap past it. The snap bar 44 and alignment rails 48 provide for alignment of the male and female snap heads, 42, 46 as the housing 12 is being closed. Openings in the housing section 14B along the alignment rails 48 provide clearance for the male snap heads. Similarity, opening along the snap bar 44 provide clearance for the female snap heads 46.

FIGS. 3A and FIG. 3B illustrate the exterior of housing sections 14A and 15B with features designed to retain and hold the graphic panels 100 including a panel capture border 50, access cut-outs 54, and lattice structure 60.

The panel capture border 50 in this embodiment comprises a short wall with rounded corners surrounding the outer edge of the housing sections 14A and 14B, The wall includes a lip 52 to allow the user to insert graphic panels 100 and display them on the leash tag 10. The panel capture border 50 includes access cutouts 54 where a portion of the lip 52 is removed to aid the user in inserting and removing the graphic panels 100 to display various messages. The access cutouts enable the user to insert a finger, nail, or coin to pry the graphic panels 100 out of the leash tag housing. Other embodiments may include a full panel capture border 50 with a continuous edge. Any of the panel capture border designs can allow for multiple graphic panels 100 to be stored within the device and provides the user with flexibility to display different messages. The panel capture border 50 is on the outside of the leash tag allowing the user to attach the body along the leash of a leash or cord and then manipulate the graphic panels 100. This design does not require the user to remove the leash tag from the leash or cord to change the graphic panels 100.

The lattice supports 60 comprises intersecting standing ribs designed to aid in snapping the leash tag together. The lattice support 60 provides structure when the leash tag 10 is placed on a table and pressed down on. The lattice supports 60 also add overall structure and rigidity to the leash tag 10. The user can press on parts of the lattice supports 60 when closing the leash tag 10 to snap the housing shut.

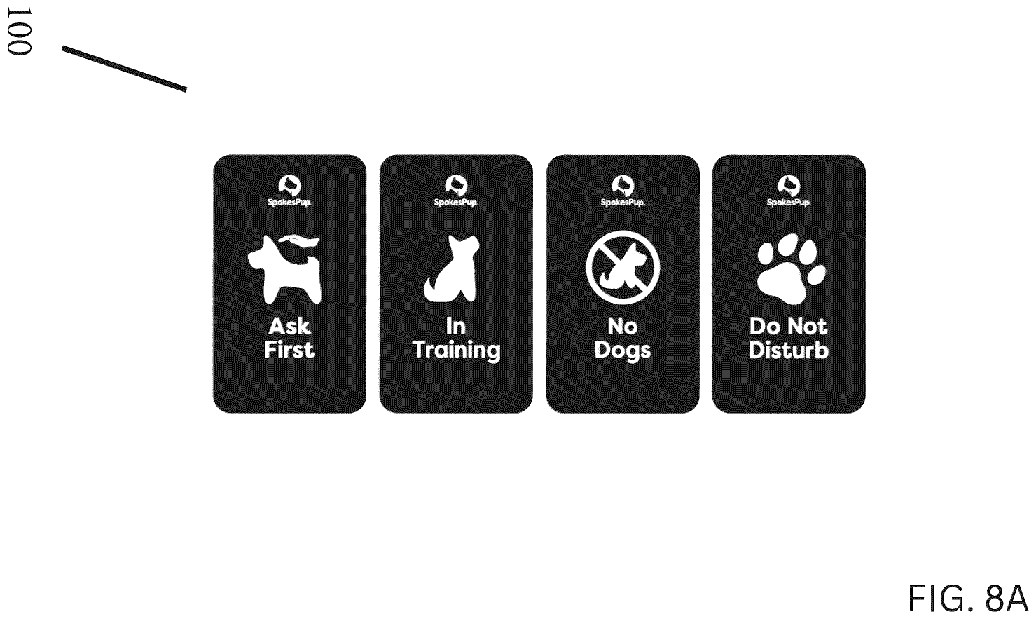

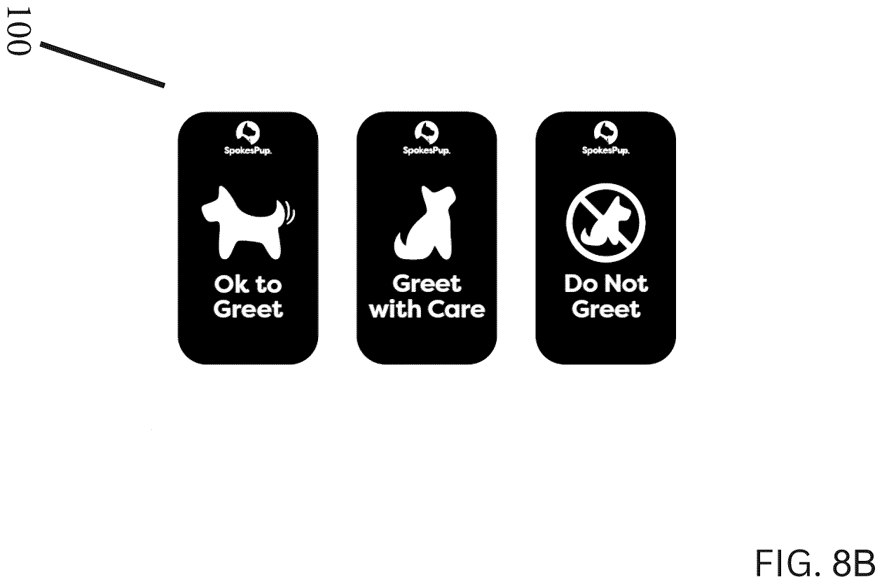

The graphic panels 100 in this embodiment (FIGS. 8A and 8B) are rectangular panels with a slight curved radius. The graphic panels 100 conform to the shape of the panel capture border 50. In FIG. 1B the graphic panels 100 are inserted underneath the lip 52 of the panel capture border 50 to secure the graphic panels 100 in place. The user can manipulate and change the graphic panels 100 as needed. The panel capture border 50 can allow for multiple graphic panels 100 to be stored within the device and provides the user with flexibility to display different messages. The panel capture border 50 is on the outside of the leash tag housing 12 allowing the user to manipulate the graphic panels 100 while the leash tag 10 is attached to the leash. Thus, the user is not required to remove the leash tag 10 from the leash in order to change the graphic panels 100.

Graphic panels 100 feature at least four unique approachability messages that each have their own color, symbol, and phrase that intuitively communicates how a dog should be approached. They also feature a quick start guide. All graphic tag panels are self-contained in the design so that the user has all graphic panels 100 available to interchange. The graphic panels 100 can be interchanged without removing the leash tag from the dog leash.

FIG. 8a shows an exemplary set of graphic panels 100. The first graphic panel 100 is green with a symbol of a hand reaching down towards a dog and the words “Ask First” printed boldly to indicate that the owner should be asked before approaching the pet. The second graphic panel 100 is yellow with a symbol of a dog sitting and the phrase “In Training” printed boldly to indicate that care should be taken when approaching the pet. The third graphic panel 100 is orange with a dog and circle with slash symbol and the words “No Dogs” printed boldly to indicate that dogs should not be allowed to approach the pet. The fourth graphic panel 100 is red with a pawprint symbol, and the words “Do Not Disturb” printed boldly to indicate that neither persons nor animals should approach the pet.

FIG. 8B shows an alternate set of graphic panels 100. The first graphic panel 100 is green with a symbol of a dog standing and the words “Ok to Greet” printed boldly to indicate that persons and animals can approach the pet. The second graphic panel is yellow with a symbol of a dog sitting and the phrase “Greet with Care” printed boldly to indicate that care should be taken when approaching the pet. The third graphic panel is red with a dog and circle with slash symbol, and the words “Do Not Greet” printed boldly to indicate that neither persons nor animals should approach the pet.

In use, the leash tags 10 are vertically oriented for maximum visibility regardless of how the leash tag 10 is rotated around the axis of a dog leash. Panels sets are provided that allow the front and back of the leash tag 10 to feature identical graphic panels 100 on both sides to communicate the same message with 360-degree visibility. The polystyrene, polyprint or similar material of the graphic panels 100 provide weather resistance, flexibility, and printability in full color. The weather resistance of our graphic panels 100 is important for all-weather use of our leash tag and ensuring the printed messages are not damaged by outdoor conditions. The flexibility of the graphic panels 100 is designed to withstand the removal, manipulation, and repetition of use for typical expected use of the leash where it might be interchanged multiple times over the course of the product life. This weather resistance and flexibility provides the necessary durability to handle typical use as a pet product. The materials used in the design of the graphic panels 100 can be printed in weather resistant inks. This will allow the tag panels to be bright, vibrant, and in full color without being compromised by outdoor elements.

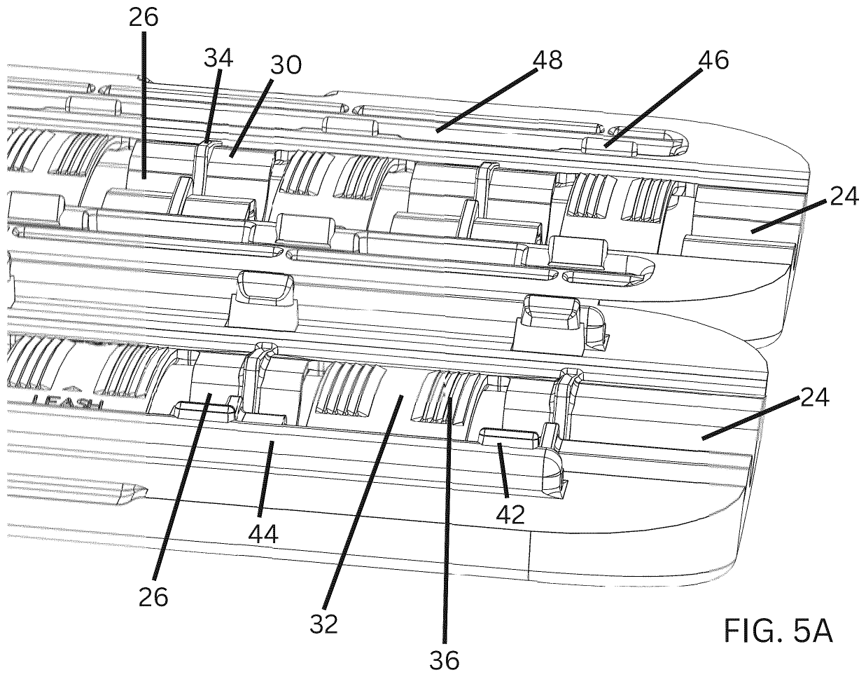

FIG. 5A is a closeup perspective showing some of the details described above.

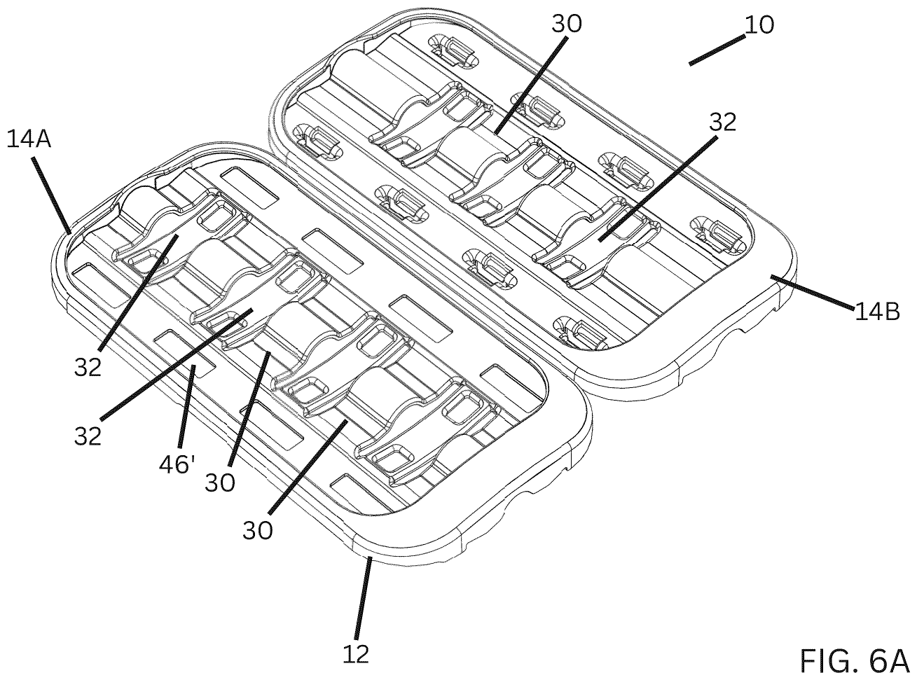

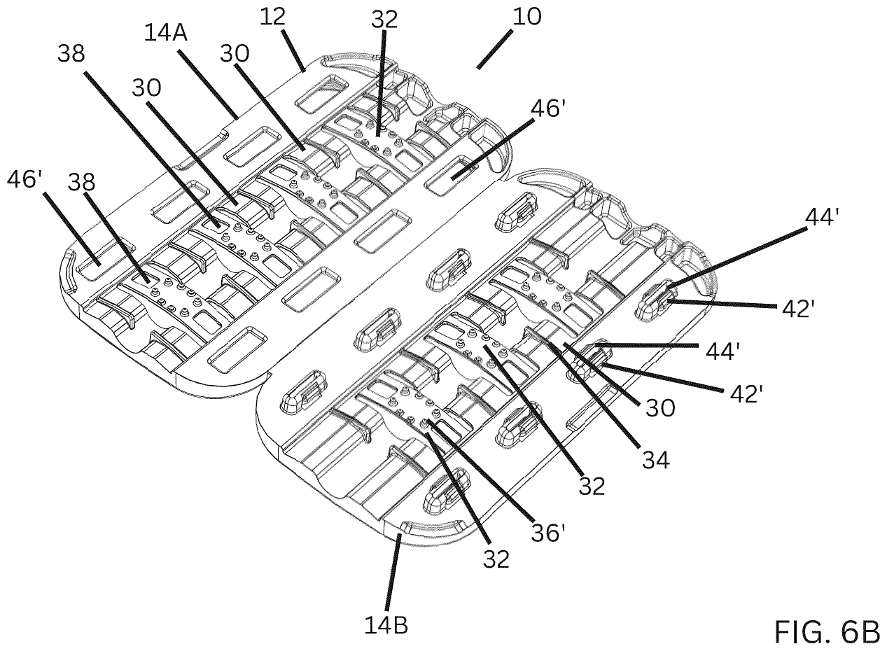

FIG. 6A and FIG. 6B illustrate an alternate embodiment of the leash tag. This embodiment is substantially similar to the embodiment shown in the previous figures, so for convenience, similar reference numbers are used to indicate similar elements. The following differences are noted.

In the embodiment shown in FIGS. 6A and 6B, the grip lines 36 on the resilient bands 32 are replaced by a pattern of raised dots 36′ on the surface of the resilient bands 32. This design allows consistent texture when contacting the leash or the cord.

The male snap head 42 and snap bars 44 in this embodiment are pill shaped designs 42′, 44′. The male snap head 42′ can be on either side of the pill shape snap bar 44′. The shortened length of the snap bars 44′ allows them to act independently and can aid in the snap force required in different materials. The snap bars 44′ in this design are hollowed out to allow them to flex out of the way and make snapping easier.

The female snap head 46′ in this embodiment is simply a rectangular cutout. The female snap head 46′ allows the male snap head 42′ and snap bar 44′ to independently pass through and engage for the snap and closing force of the device. The openings of the female snap heads 46′ aligned with each independent male snap head 42′ and snap bar 44′ ensure a secure fit. The male snap heads 42′ must move past the female snap head 46′ and then lock into place on the other side.

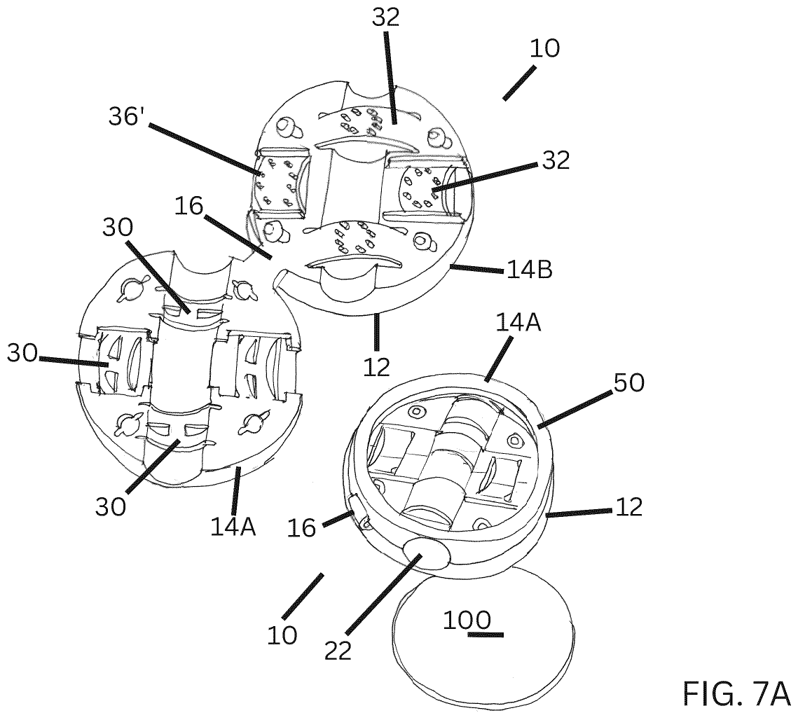

It is not essential that the housing 12 be rectangular; other geometric forms and shapes can be used. FIG. 7A shows an alternate design with a generally circular housing 12. This design includes two intersecting channels 22; one for a circular leash and one for a flat leash. Resilient bands 30, 32 extend transversely across the channels 22 to press on the leash when the housing 12 is closed. In this embodiment the male snap heads 42′ are a mushroom top shape. The female snap heads 46′ are circular slotted openings that can accept the mushroom top shape of the male snap heads 42′. Various snapping and closure methods can be used to close the two halves of the enclosure together.

In this embodiment the panel capture border 50 is circular with a continuous border. This design is to capture and hold the circular design of the graphic panel 100.

The other features function are similar to the other embodiments to capture a leash or a cord and display a graphic panel 100 along the length of the leash or cord.

### Design Functionality

The leash tag 10 attaches along the length of a dog leash or cord. It captures a variety of leash or cord sizes, shapes, and thicknesses. The anti-slip features hold the leash tag 10 0 in place along the length of a leash or cord. When closed the leash or cord is captured between the two halves of the housing 12 in dedicated recesses along the longitudinal length that are designed to provide clamping and frictional force to the leash. The clamping force engages anti-slip design elements within the recesses to hold the leash in place during normal use. The clamping force keeps the leash tag 10 from sliding horizontally and vertically down the leash, to provide adequate visibility for the leash tag on leashes or cords.

The vertical orientation of the leash tag 10 is purposeful to maintain 360 degrees of visibility for both sides of the leash tag and the graphic tag panels. Furthermore, the text on these graphic panels is written vertically so that they are legible in all degrees of view. As a leash tag 10 is rotated around the axis of the leash in typical use it is always legible and one or both sides of the leash tag 10 will be in view of others. The leash tag 10 is designed to be interchangeable while attached to the leash. Users can remove the graphic panels 100 and flip or change them on each side of the leash to display the desired message for their dog. This can also be done while the leash tag 10 is removed from a dog leash. This flexibility allows the leash tag to be known for multiple standardized messages and to adapt to the needs of dogs.

### Materials

The leash tag 10 can be produced in almost any flexible material such as: TPE, Silicone, Polyurethane, polypropylene, or materials with similar characteristics. It could also be produced in stiffer materials, such as hard plastics, metals, and other natural materials. The materials chosen are to balance the needs of flexibility to accommodate a variety of leash sizes and shapes with stiffness suitable for sufficient clamp force in our design. Some stiffness is required to hold its shape.

Polystyrene, polyester synthetic paper, or any flexible printable material can be used to create the graphic panels 100 that show the message that the user chooses to display and can be housed inside the leash tag. Graphic panels 100 can have information on two faces, front and back. Other printed materials can be used to create a graphic panel 100 such as various treated papers that have a level of water resistance, synthetic, and natural materials.

What is claimed is:

1. A pet leash tag comprising:
a housing having a channel formed therein enabling a pet leash to pass through the housing, the housing comprising:
first and second housing sections that close together with the pet leash captured in the channel;
a plurality of bands extending transversely relative to the channel and configured to compress the pet leash when the housing sections are closed to prevent the pet leash from slipping on the leash;
a plurality of interchangeable graphic panels removably attachable to an exterior of at least one of the housing sections.

2. The pet leash of claim 1, wherein the channel is defined by a series of channel sections spaced along a common axis in an interior of the housing, each of the channel sections being formed in one of the housing sections.

3. The pet leash of claim 2, wherein the channel sections include opposing channel sections formed in the interior of the first and second housing sections respectively that surround the pet leash when the housing sections are closed.

4. The pet leash of claim 3, wherein the opposing channel sections in the first and second housing sections define channel openings at opposite ends of the housing when the first and second housing sections are closed.

5. The pet leash of claim 4, wherein the resilient bands comprise a plurality of first resilient bands spaced along the common axis, each of the first resilient bands including a respective channel section.

6. The pet leash of claim 5, wherein the resilient bands comprise a plurality of second resilient bands spaced along the common axis directly opposite a respective channel section to compress the pet leash passing through the respective channel section.

7. The pet leash of clam 6, wherein the first and second bands are arranged in alternating fashion on each of the first and second housing sections respectively and are staggered on the first and second housings so that each of the first bands is opposite a respective second band and each of the second bands is opposite a respective channel section.

8. The pet leash of claim 6, wherein the first resilient bands include standing ribs configured to pinch a portion of the pet leash passing through the channel section in the first resilient band.

9. The pet leash of claim 6, wherein the second resilient bands include grip features to increase gripping on the pet leash.

10. The pet leash of claim 6, wherein one or more of the second resilient bands includes cutouts to increase flexibility.

11. The pet leash of claim 1, further comprising a live hinge connecting the first and second housing sections.

12. The pet leash of claim 2, further comprising a closure mechanism to secure the housing sections in a closed position.
